(19) United States
(12) Patent Application Publication
(10) Pub. No.: US 2026/0104093 A1
(43) Pub. Date: Apr. 16, 2026

(54) Sealing Profile

(71) Applicant: Binder GmbH, Tuttlingen (DE)

(72) Inventors: Ahmet ARABUL, Tuttlingen (DE); Jochen BUSCHLE, Tuttlingen (DE); Ewald STORZ, Rietheim-Weilheim (DE); Philipp ZIMMERER, Rottweil (DE)

(73) Assignee: Binder GmbH, Tuttlingen (DE)

(21) Appl. No.: 19/353,567

(22) Filed: Oct. 8, 2025

(30) Foreign Application Priority Data
Oct. 14, 2024 (DE) 1020241296909

(51) Int. Cl. F16J 15/10

(52) U.S. Cl. CPC F16J 15/104

(57) ABSTRACT

Disclosed is a sealing profile for sealing a gap between a door and a door stop of a climate chamber. The sealing profile is configured as a hollow profile having a wall with an inner side, enclosing at least one hollow volume, and an outer side. The hollow profile includes a heating element pocket formed by a segment of the outer side and configured to receive a heating element. The heating element pocket comprises a heating element compartment and an access channel. In a first state of the sealing profile, the access channel has a width in cross-section that is smaller than the diameter of the heating element, thereby retaining the heating element within the compartment. The sealing profile is deformable to allow widening of the access channel for insertion and removal of the heating element, enabling replacement of damaged heating elements without replacing the entire sealing profile.

### CROSS-REFERENCE TO RELATED APPLICATIONS AND INCORPORATION BY REFERENCE

This application claims the benefit of priority under 35 U.S. C. § 119(a) to German Patent Application No. DE 10 2024 129 690.9, filed Oct. 14, 2024, which is hereby incorporated by reference in its entirety.

### FIELD OF DISCLOSURE

The application relates to a sealing profile for sealing a gap between a door and a door stop.

### BACKGROUND

Climate chambers in various physical forms are known in the prior art and are employed in scientific laboratories or industrial operations for the purpose of simulating biological, chemical and/or physical environmental conditions, such as for example temperature, atmospheric pressure and/or humidity. A climate chamber comprises a housing with an inner volume or interior within the housing, wherein in the inner volume the biological, chemical, and/or physical environmental conditions are simulated.

Known are climate chambers with a housing with at least one base body comprising a door and an inner volume sealable by means of the at least one door. Therein in a closed position the door is intended to fit as tightly as feasible against a door stop disposed on the base body. The door stop can herein be disposed on a stationary portion of the base body, for example a door frame, as well as also on a further door in the event the climate chamber comprises a double wing door.

The doors of the climate chambers not only enable physical access to the inner volume but must also comprise thermal insulation as a wall in order to thermally decouple the inner volume from its surroundings. In the interior of the climate chamber a desired climate can be set in particular by regulating the temperature and/or the humidity. Climate chambers can typically be set to temperatures between −10° C. and 100° C., however there are likewise climate chambers for high temperature ranges in which temperatures of up to 350° C. can be set over long periods in the inner volume or also deep-freeze devices in which temperatures down to −85° C. can be set for long periods of time. Herein the doors must have sufficient insulation, on the one hand, and, in addition, must furthermore seal tightly the gap between the door and door stop such that, aside from heat exchange with the surroundings, mass exchange can also be prevented as well. It is known to provide for this purpose a sealing on the door or on the door stop.

Due to the high temperature differences there is however a risk of condensate formation and/or ice formation in the proximity of the sealing.

To eliminate this drawback it is known to heat the sealing. For example DE 951 573 A discloses an elastic sealing with a heating wire disposed in the core. Of disadvantage in the case of such sealing is that it must be completely replaced if the heating wire is damaged. To avoid the formation of condensate on margin regions of glazings DE 38 02 077 A1 discloses an elastic sealing into which a heating wire is emplaced into a groove of the sealing. However, unless the heating wire in the groove is covered by a fixed element or is adhered in the groove there is a risk of the heating wire falling out.

### SUMMARY

The application therefore addresses the problem of providing a sealing profile with a heating element which enables changing the heating element.

Advantageous embodiments and further developments of the application are specified in the dependent claims.

The sealing profile for sealing a gap between a door and a door stop is developed as a hollow profile with a wall comprising an inner side and an outer side and with its inner side encloses at least one hollow volume, wherein the hollow profile comprises a heating element pocket, formed by a segment of the outer side, in which a heating element with a diameter is disposed, wherein the heating element pocket comprises a heating element compartment and an access channel, wherein in a first state of the sealing profile the access channel in cross section of the sealing profile has a width which is less than the diameter of the heating element.

Thereby that the heating element pocket is formed by a segment of the outer side of the hollow profile, it is accessible from the outside whereby removing the heating element from the heating element pocket and setting the heating element into the heating element pocket are enabled.

Thereby that the access channel in a first state of the sealing profile, in cross section of the sealing profile, has a width which is less than the diameter of the heating element, yet the heating element is disposed in the sealing profile such that it is ensured against falling out. As the first state of the sealing profile can be considered in particular the nondeformed state of the sealing profile or, stated differently, the nonloaded state of the sealing profile. However, the sealing profile is deformable such that in a deformed state, the access channel is widened such that removing the heating element from the heating element pocket and setting the heating element into the heating element pocket are feasible. For this purpose the sealing profile is reversibly deformable.

According to an especially preferred embodiment of the sealing profile is fabricated of an elastically deformable material, preferably of a synthetic material, in particular preferred of a silicone. Utilization of such material promotes the elastic properties of the sealing profile. The sealing profile can herein preferably be produced in an extrusion process.

On the outer side of the wall of the hollow profile in the access channel preferably at least one projection, preferably two projections, are disposed. The projection or the projections narrow the access channel substantially at points such that the danger of a user accidentally touching the heating element is reduced.

A preferred further development provides for the access channel in cross section of the sealing profile to comprise a curved or angular course. The danger that a user unintentionally touches the heating element can thereby be further reduced.

The sealing profile advantageously comprises a securement foot and/or a securement groove. Such implementation enables in simple manner securing the sealing profile, for example, thereby that the securement foot is pressed into a corresponding groove or the securement groove is slid over a corresponding securement plate.

On the outer side of the wall of the securement foot and/or of the securement groove preferably at least one holding means is disposed which is preferably developed as a holding lip or a holding rib. Such holding means can increase the frictional or force-tractional contact closure and improve the securement of the sealing profile.

According to a preferred embodiment of the heating element is developed as a wire with a silicone sheathing. Such heating elements can be fabricated simply and cost-effectively.

The heating element is preferably connected across a clamp connection to an external electrical energy source, preferably to a low voltage direct current source, whereby in simple manner a secure power supply can be enabled.

A sealing profile is preferably employed in a climate chamber which comprises a door, swivellable between an open and a closed position, and a door stop and wherein the sealing profile is disposed on the door or on the door stop, preferably on the door stop.

The sealing profile preferably comprises a securement foot, which is set into a groove of the climate chamber preferably disposed for example on the door or on the door stop, preferably on the door stop, wherein the heating element and preferably the access channel is disposed in a portion of the sealing profile projecting over the groove. Such disposition facilitates the accessibility of the heating element. Such implementation in particular enables replacing a damaged heating element without the sealing having to be removed from the climate chamber.

### BRIEF DESCRIPTION OF THE DRAWINGS

An embodiment example will be described in detail in conjunction with the following Figures. Therein depict:

FIG. 1 a cross section of an embodiment example of a sealing profile in nondeformed state,

FIG. 2 the cross section of the sealing profile according to FIG. 1 with set-in heating element,

FIG. 3 a further cross section of the sealing profile according to FIG. 1 at the level of an access channel,

FIG. 4 a partially sectioned perspective view of the peripheral sealing profile according to FIG. 1,

FIG. 5 the view of the sealing profile according to FIG. 4 with set-in heating element,

FIG. 6 a perspective view of an embodiment example of a climate chamber with a base body and two doors in an open position, wherein on the base body a sealing profile according to FIG. 1 is disposed,

FIG. 7 a perspective view onto the climate chamber according to FIG. 6 with the doors in a closed position,

FIG. 8 a view from above onto the climate chamber according to FIG. 7,

FIG. 9 a detail enlargement of a cross section through the climate chamber according to FIG. 8, wherein the sealing profile is depicted in the nonloaded state in spite of the closed door,

FIG. 10 the view according to FIG. 9 with the heating element removed.

### DETAILED DESCRIPTION

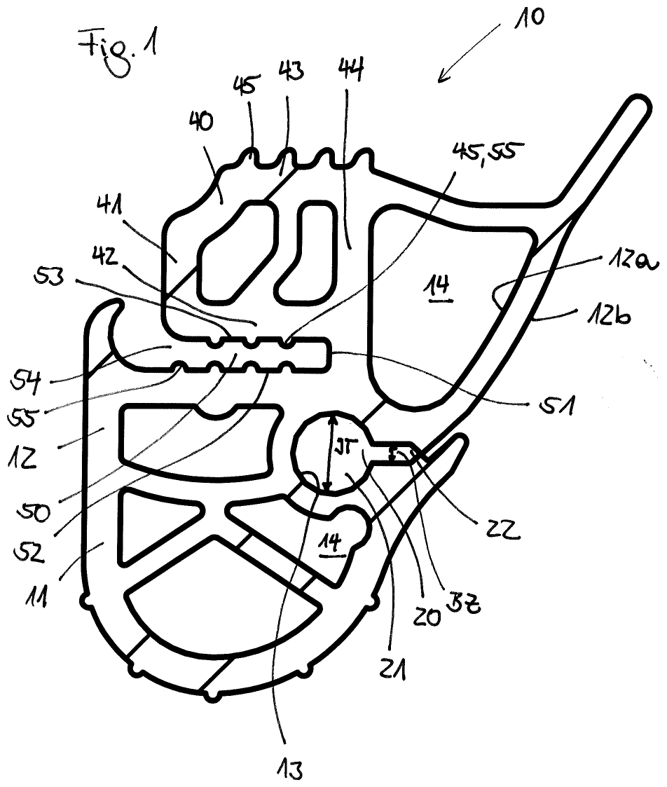

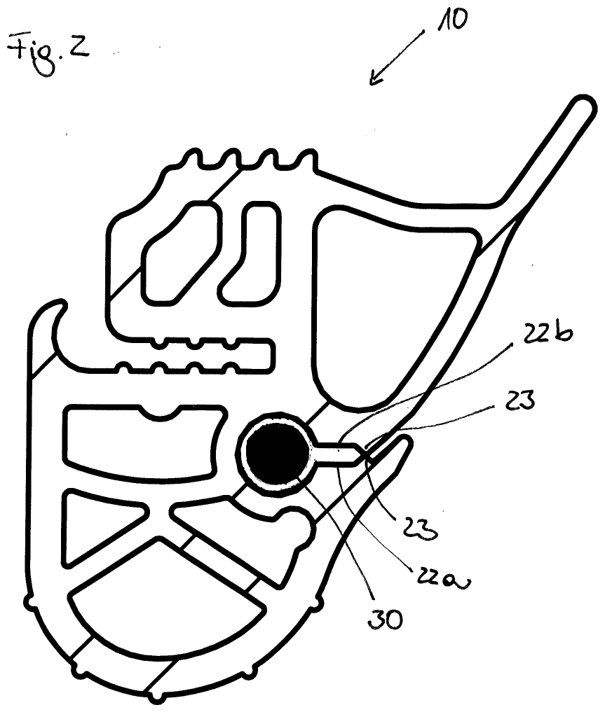

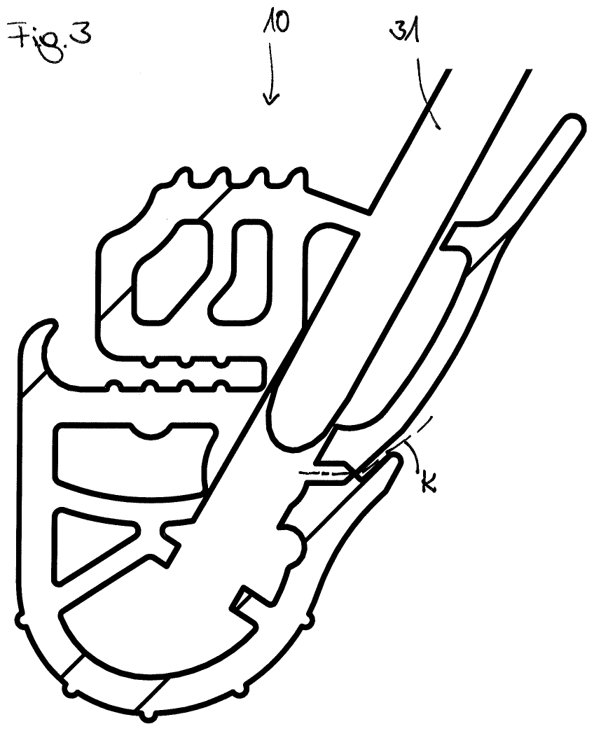

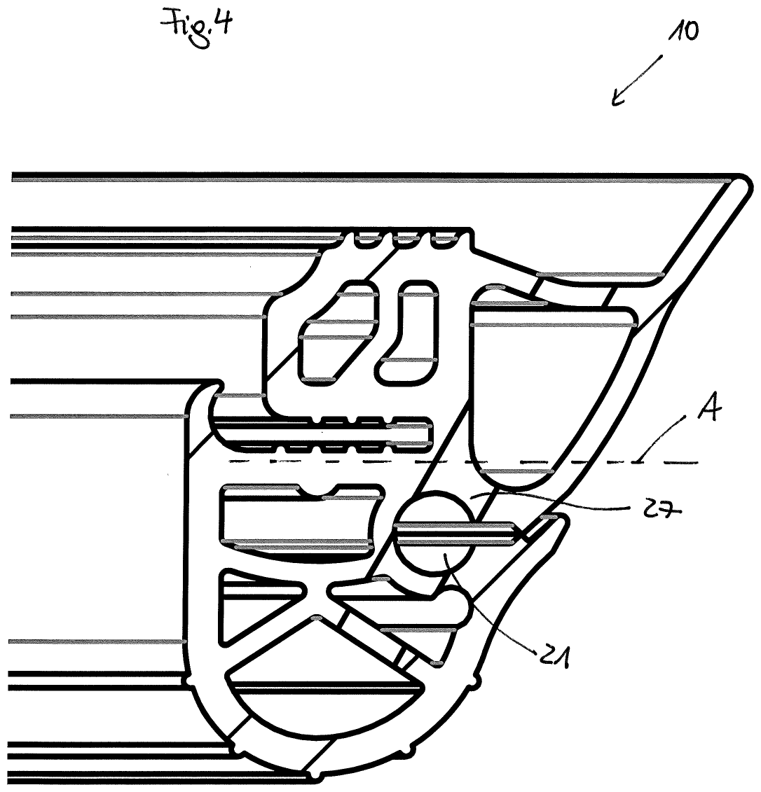

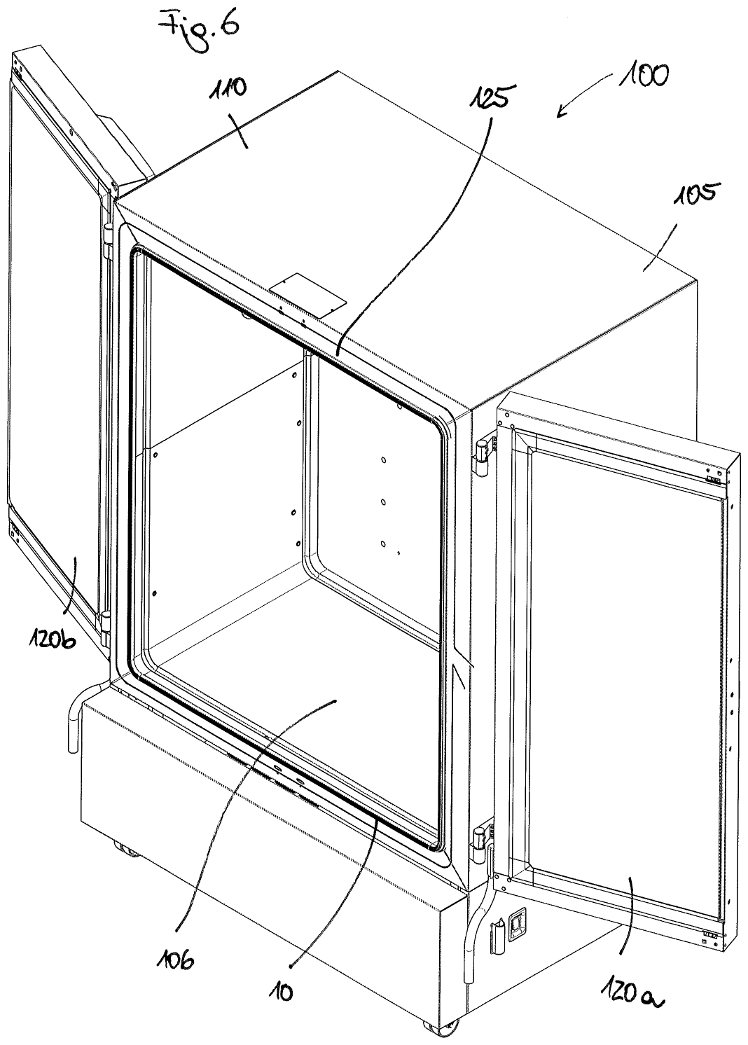

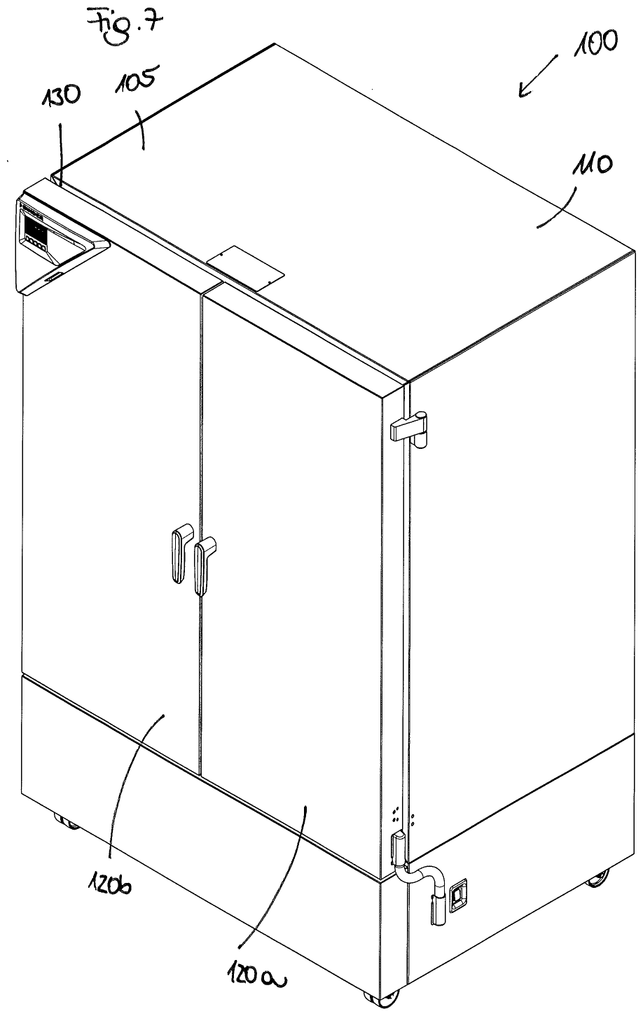

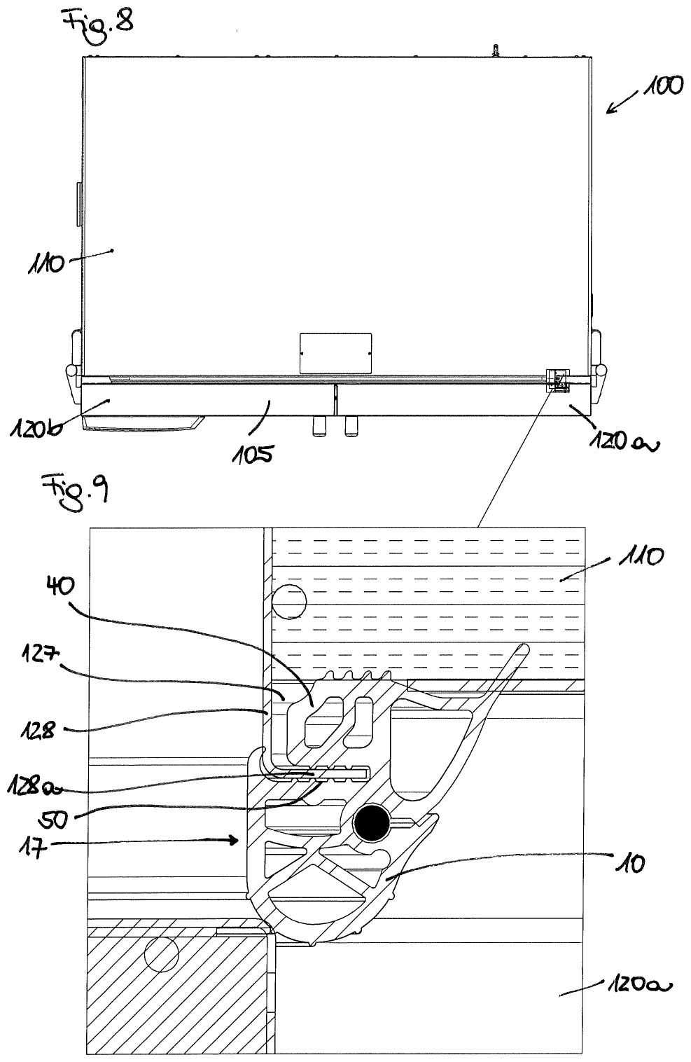

FIGS. 1 to 5 show views of an embodiment example of a sealing profile 10, FIGS. 6 to 10 illustrate the installation of such sealing profile 10 into a climate chamber 100. Same or functionally same parts are identified by same reference numbers, wherein, for the sake of clarity of view, not all reference numbers are provided in all Figures.

The sealing profile 10 is developed as a hollow profile 11 with a wall 12 comprising an inner side 12a and an outer side 12b. With the inner side 12a is enclosed at least one hollow volume 14. The sealing profile 10 can be fabricated of an elastically deformable material, for example a synthetic material, in particular a silicone, and be produced, for example, in an extrusion process. The sealing profile 10 comprises a longitudinal axis A that extends perpendicularly to the cross section depicted in FIG. 1.

The hollow profile 11 comprises a heating element pocket 20, formed by a segment 13 of the outer side 12b, in which a heating element 30 is disposed. The heating element 30 comprises a longitudinal axis LH and an outer diameter DH and can be developed, for example, as a wire with a silicone sheathing.

The heating element pocket 20 is disposed such that it extends in particular parallel to the longitudinal axis A of the sealing profile 10. When the heating element 30 is disposed in the heating element pocket 20, the longitudinal axis LH of the heating element 30 also extends substantially parallel to the longitudinal axis A of the sealing profile 10.

The heating element pocket 20 comprises a heating element compartment 21 and an access channel 22. The heating element compartment 21 can be developed in cross section for example approximately round and have an inner diameter IT that is slightly larger than the outer diameter DH of the heating element 30 such that the heating element 30 can be disposed substantially under form closure in the heating element pocket 20. In a first state of the sealing profile 10, which in particular is a nondeformed state of the sealing profile 10, the access channel 22, in cross section of the sealing profile 10, has a width BZ which is smaller than the diameter DH of the heating element 30 and therewith in particular also smaller than the inner diameter IT of the heating element compartment 21. The heating element pocket 20 can therewith have a cross section in the manner of a keyhole. The heating element 30 can thereby be disposed in the heating element compartment 21 such that it is ensured against the risk of falling out and be protected.

On the outer side 12b of the wall 12 of the hollow profile 11 at least one projection 23 can be disposed in the access channel 22. In the depicted embodiment example on the outer side 12b of wall 12 of the hollow profile 11, two projections 23 are disposed in the access channel 22, for example, such that they are disposed on opposite side faces 22a, 22b of the access channel 22 and project into the access channel 22 such that in the nondeformed state of the sealing profile 10 they are in contact with one another. These projections 23 narrow the access channel 22 or preferably close it off. The heating element 30 can thereby be disposed in the heating element compartment 21 such that it is protected against contaminants.

In the cross section of the sealing profile 10 the access channel 22 can have a curved or angular course K. The curved or angular course K is indicated in FIG. 3 by the dashed line denoted by K.

Thereby that the heating element pocket 20 is formed by the segment 13 of the outer side 12b of the wall 12, the heating element pocket 20 is open toward the outside. In cross section radially bordering the heating element pocket 20 is disposed the at least one hollow volume 14. The sealing profile 10 comprises in particular at least two hollow volumes 14, wherein in cross section of the sealing profile 10 in the direction transversely to the access channel 22 one of the two hollow volumes 14 is disposed on each side of the access channel 22.

In order to be able to emplace the heating element 30 in the heating element compartment 21 or remove it therefrom, the sealing profile 10 can be deformed such that the access channel 22 is widened, in particular by bending the two opposite side faces 22a, 22b of the access channel 22 away from one another. This can be enabled, in particular, through the hollow volumes 14 disposed in the sealing profile 10.

The sealing profile 10 can comprise a securement foot 40 and/or a securement groove 50. The depicted sealing profile 10 comprises the securement foot 40 as well as also the securement groove 50.

The securement foot 40 can be developed approximately rectangular in cross section of the sealing profile 10 with a base side 41, two oppositely disposed side faces 42, 43 and an upper side or surface 44. The upper side 44 can be disposed approximately in the radial direction with respect to the portion of segment 13 of wall 12 delimiting the heating element compartment 21. The two side faces 42, 43 extend substantially perpendicularly to the upper side 44, while the base side 41 connects the two ends of side faces 42, 43 pointing away from the upper side 44. The base side 41 and the two side faces 42, 43 can herein be portions of the outer side 12b of the wall 12 of the hollow profile 11. The upper side 44 can at least sectionally be disposed as an inner web on the securement foot 40 and one of the hollow volumes 14. On the outer side 12b of wall 12 of the securement foot 40, in particular on the side faces 43 42, 43 at least one holding means 45, in the present case several holding means 45, can be disposed which can be developed, for example, as holding lips or holding ribs.

In a cross section of the sealing profile 10, the securement groove 50 can be developed approximately rectangularly with a bottom face 51, two oppositely disposed side walls 52, 53 and an opening 54 located opposite the bottom face 51. The bottom face 51 can be disposed approximately in the radial direction with respect to the portion of the segment 13 of the wall 12 delimiting the heating element compartment 21 and be developed, for example, through a segment of the upper side 44 of the securement foot 40. The two side walls 52, 53 extend substantially perpendicularly to the bottom face 51.

The bottom face 51 and the two side walls 52, 53 can herein be a portion of the outer side 12b of the wall 12 of the hollow profile 11. Therewith the securement groove 50 is open toward the outside. In particular in the present embodiment example the side wall 53 of the securement groove 50 is formed by the side face 42 of the securement foot 40. On the outer side 12b of wall 12 of the securement groove 50, in particular on the side walls 52, 53 at least one holding means 55, in the present case several holding means 55, can be disposed which can be developed, for example as holding lips or holding ribs. In the present embodiment example the holding means 55 of the securement groove 50 are partially formed by the holding means 45 of the securement foot 40.

The climate chamber 100 depicted in FIGS. 6 to 10 comprises a housing 105 with a base body 110 and at least one door 120a swivellable between an open and a closed position, in the present case two doors 120a, 120b, swivellable between an open and a closed position, wherein the housing 105 encloses an inner volume 106. The climate chamber 100 comprises further a door stop 125 for the door 120a. If precisely only one door 120a is provided, the door stop 125 can be disposed completely on the base body 110. If, as depicted in the present embodiment example, the climate chamber 100 comprises two doors 120a, 120b, the door stop 125 for the door 120a, at least for the free front edge of the door 120a, can be disposed on the other door 120b. The door stop 125 for the upper edge and lower edge of door 120a can be disposed on the base body 110. In the present case the door stop 125 is disposed peripherally about the side panel sealable by the doors 120a, 120b, of the base body 110. The door stop, disposed between the front edges of doors 120a, 120b, in the present embodiment example is not further relevant.

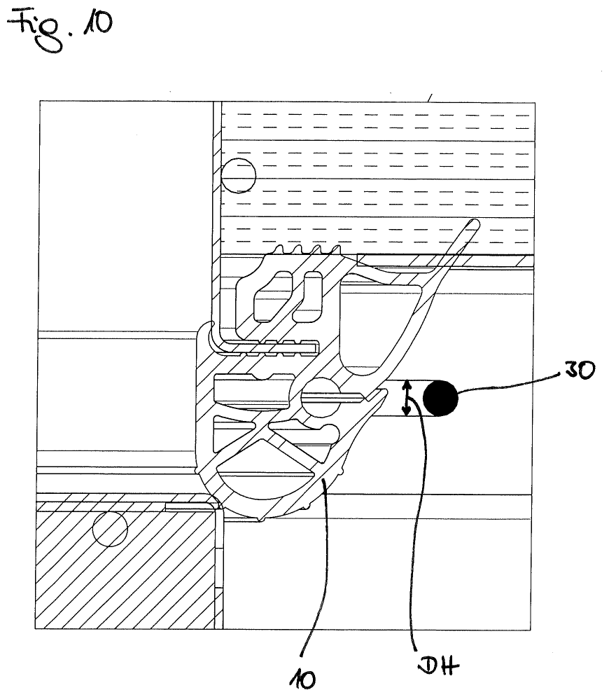

The sealing profile 10 is developed for sealing a gap 130 between doors 120a, 120b, on the one hand, and, on the other hand, the door stop 125. To this end, the sealing profile 10 can be disposed on the base body 110, in particular in a groove 127, which can be disposed on the front face pointing to the doors 120a, 120b of the base body 110. The sealing profile 10 is herein developed in particular peripherally. The groove 127 can herein be delimited in particular by an L-shaped angular plate 128, which is disposed with a free shank 128a spaced apart from the base body 110. The sealing profile 10 can be set with the securement foot 40 into the groove 127 (cf. FIGS. 9 and 10). The free shank 128a of the plate 128 sectionally delimiting the groove 127 can simultaneously engage into the securement groove 50 (cf. FIGS. 9 and 10).

The holding means 45, 55 can herein ensure sufficient purchase. The deformation of the holding means 45, 55 is not depicted in FIGS. 9 and 10.

When the sealing profile 10 is set with the securement foot 40 into the groove 127, a portion 17 of the sealing profile 10 projects beyond the groove 127. The heating element 30 and preferably the access channel 22 of the heating element pocket 20 are in particular disposed in this portion 17 projecting beyond the groove 127 of the sealing profile 10. This enables removing the heating element 30, as depicted in FIG. 10, from the sealing profile 10, even if the sealing profile 10 is disposed on the climate chamber 100, in particular set into the groove 127, since the projecting portion 17 can be appropriately deformed in order to open the access channel 22 and to remove the heating element 30.

If the heating element 30 is defective, the replacement can be accomplished without tools and without major expenditures.

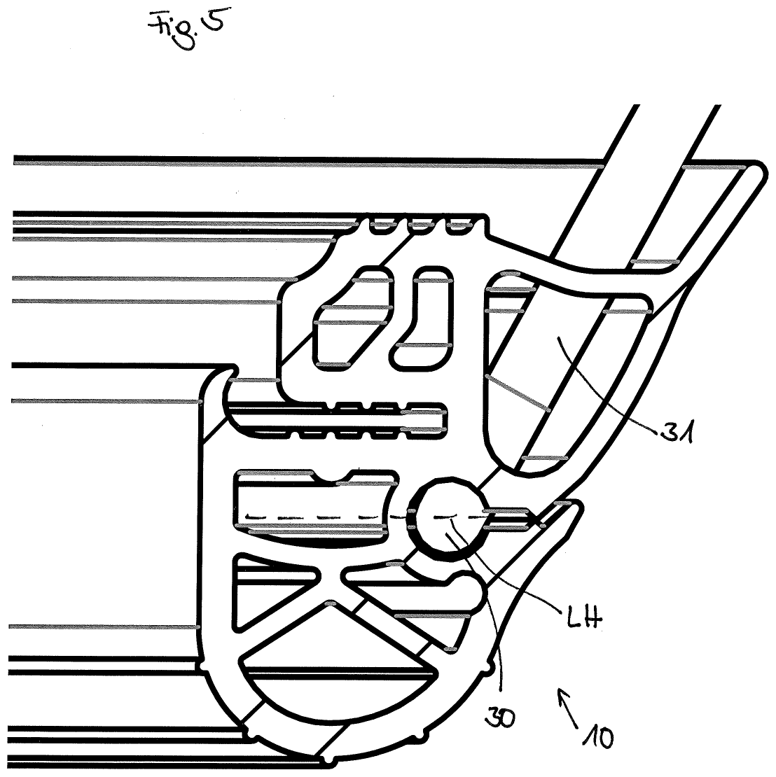

The heating element 30 can be connected across a clamp connection to an external power source, preferably to a low voltage direct current source. For this purpose the heating element 30 can be disposed, in particular, with a feed segment 31 on a feed channel 27 of the sealing profile 10, which feed channel 27 is disposed in particular transversely to the longitudinal axis A of the sealing profile 10 and therewith to the longitudinal axis of the heating wire or element pocket 20 in the sealing profile 10 (cf. in particular FIGS. 3 and 5). This enables disposing the electrical power source for the heating element 30 outside of the sealing region between the doors 120a, 120b and the door stop 125, for example on a side panel of the base body 110 of the climate chamber 100.

In the event of a defect of the heating element 30, for the replacement of the heating element 30 the clamp connection can in particular also be detached without tools, the heating element 30 disposed peripherally in the sealing profile 10 can be removed by deforming the sealing profile 10 and a new heating element 30 can be emplaced in the heating element pocket 20 of the sealing profile 10 and subsequently be connected again with the power source, in particular without special tools being required, and in particular without a replacement of the complete sealing profile 10 being required.

### LIST OF REFERENCE SYMBOLS

10 Sealing profile
11 Hollow profile
12 Wall
12a Inner side
12b Outer side
13 Segment
14 Hollow volume
17 Portion
20 Heating element pocket
21 Heating element compartment
22 Access channel
22a Side face
22b Side face
23 Projection
27 Feed channel
30 Heating element
31 Feed segment
40 Securement foot
41 Base side
42 Side face
43 Side face
44 Upper side
45 Holding means
50 Securement groove
51 Bottom face
52 Side wall
53 Side wall
54 Opening
55 Holding means
100 Climate chamber
105 Housing
106 Inner volume
110 Base body
120a Door
120b Door
125 Door stop
127 Groove
128 Plate
128a Shank
130 Gap
A Longitudinal axis of the sealing profile
IT Inner diameter of the heating element compartment
BZ Width of the access channel
DH Outer diameter of the heating element
LH Longitudinal axis of the heating element
K Course

We claim:

1. A sealing profile for sealing a gap between a door and a door stop, comprising:
a hollow profile having a wall with an inner side and an outer side, the inner side enclosing at least one hollow volume;
a heating element pocket formed by a segment of the outer side, the heating element pocket configured to receive a heating element having a diameter;
wherein the heating element pocket comprises a heating element compartment and an access channel; and
wherein in a first state of the sealing profile, the access channel in cross section of the sealing profile has a width that is smaller than the diameter of the heating element.

2. The sealing profile of claim 1, wherein the sealing profile is fabricated of an elastically deformable material.

3. The sealing profile of claim 2, wherein the elastically deformable material comprises silicone.

4. The sealing profile of claim 1, wherein at least one projection is disposed on the outer side of the wall of the hollow profile in the access channel.

5. The sealing profile of claim 1, wherein the access channel in cross section of the sealing profile comprises a curved or angular course.

6. The sealing profile of claim 1, further comprising a securement foot.

7. The sealing profile of claim 1, further comprising a securement groove.

8. The sealing profile of claim 6, wherein at least one retention element is disposed on the outer side of the wall of the securement foot.

9. The sealing profile of claim 7, wherein at least one retention element is disposed on the outer side of the wall of the securement groove.

10. The sealing profile of claim 8, wherein the retention element comprises a lip or rib structure.

11. The sealing profile of claim 1, wherein the heating element comprises a wire with a silicone sheathing.

12. The sealing profile of claim 1, wherein the heating element is connected via a clamp connection to an external electrical power source.

13. The sealing profile of claim 6, wherein the securement foot is configured to be inserted into a groove of a climate chamber.

14. The sealing profile of claim 13, wherein the heating element and the access channel are disposed in a portion of the sealing profile projecting over the groove.

15. The sealing profile of claim 7, wherein the securement groove is configured to receive a securing element of a climate chamber.

16. The sealing profile of claim 1, wherein the access channel connects the heating element compartment to an exterior of the sealing profile and wherein the sealing profile is deformable from the first state to a second state in which the access channel is widened to allow insertion and removal of the heating element through the access channel.

17. A climate chamber comprising:
a housing having a base body;
a door swivellable between an open position and a closed position;
a door stop; and
a sealing profile disposed on the door or the door stop, the sealing profile comprising:
a hollow profile having a wall with an inner side and an outer side, the inner side enclosing at least one hollow volume;
a heating element pocket formed by a segment of the outer side and configured to receive a heating element having a diameter;
wherein the heating element pocket comprises a heating element compartment and an access channel; and
wherein in a first state of the sealing profile, the access channel in cross section of the sealing profile has a width that is smaller than the diameter of the heating element.
